(19) United States
(12) Patent Application Publication
(10) Pub. No.: US 2012/0054762 A1
(43) Pub. Date: Mar. 1, 2012

(54) SCHEDULING APPARATUS AND METHOD FOR A MULTICORE DEVICE

(75) Inventors: Bo-Seok MOON, Seoul (KR); Sung-Min LEE, Suwon-si (KR); Sang-Bum SUH, Seoul (KR)

(73) Assignee: Samsung Electronics Co., Ltd, Suwon-si (KR)

(21) Appl. No.: 13/052,322

(22) Filed: Mar. 21, 2011

(30) Foreign Application Priority Data
Aug. 25, 2010 (KR) 10-2010-0082695

(51) Int. Cl. G06F 9/46

(52) U.S. Cl. 718/103

(57) ABSTRACT

A scheduling technique for a multicore device is provided. A scheduling apparatus for a multicore device calculates decision values for matrix elements of a decision matrix composed of virtual CPUs assigned to physical CPUs, selects a virtual CPU corresponding to a matrix element having the greatest decision value among the calculated decision values, and changes a currently executed virtual CPU of the physical CPU where the virtual CPU migration event has been generated, into the selected virtual CPU.

### CROSS-REFERENCE TO RELATED APPLICATION(S)

This application claims the benefit under 35 U.S.C. §119(a) of Korean Patent Application No. 10-2010-0082695, filed on Aug. 25, 2010, in the Korean Intellectual Property Office, the entire disclosure of which is incorporated herein by reference for all purposes.

### BACKGROUND

1. Field

The following description relates to a central processing unit (CPU) scheduling technique, and more particularly, to a scheduling technique for a multicore device.

2. Description of the Related Art

Core virtualization is essential in a multicore device that includes a plurality of cores, for example, at least two physical CPUs. A multicore based operating system (OS) may be assigned virtual CPUs to perform tasks. For example, physical CPUs may be virtualized to create several virtual CPUs. The OS may occupy the virtual CPUs scheduled in a hypervisor level to perform specific tasks. In this process, a scheduler for appropriately assigning the virtual CPUs to the OS is needed.

### SUMMARY

In one general aspect, there is provided a scheduling apparatus for a multicore device including at least two cores, the scheduling apparatus comprising an event detector configured to detect a virtual central processing unit (CPU) migration event with respect to a physical CPU of the multicore device, a matrix calculator configured to calculate decision values for matrix elements of a decision matrix which correspond to virtual CPUs that are assigned to physical CPUs, in response to a virtual CPU migration event with respect to the physical CPU being detected by the event detector, a CPU selector configured to select a virtual CPU corresponding to a matrix element that has the greatest decision value from among the calculated decision values, and a virtual CPU migration unit configured to change a currently executed virtual CPU of the physical CPU in which the virtual CPU migration has been detected, into the virtual CPU selected by the CPU selector.

The matrix calculator may calculate the decision values for the matrix elements of the decision matrix in consideration of a plurality of decision factors.

The decision factors may include weights corresponding to scheduling ratios of the physical CPUs.

The matrix calculator may differentiate the weights based on differences between actual scheduling ratios and initial scheduling setting ratios of the physical CPUs.

The decision factors may include weights corresponding to workloads of the physical CPUs.

The matrix calculator may differentiate the weights based on a number of virtual CPUs that have priorities that are higher than a predetermined priority from among the virtual CPUs assigned to the physical CPUs.

The matrix calculator may differentiate the weights based on a total number of scheduling operations by virtual CPUs that have priorities that are higher than a predetermined priority from among the virtual CPUs assigned to the physical CPUs.

The decision factors may include a weight for a virtual CPU that has the highest scheduling priority from among the virtual CPUs.

In response to there being two or more matrix elements that have decision values calculated by the matrix calculator as the greatest value, the virtual CPU selector may select a virtual CPU that has a minimum number of scheduling operations from among the virtual CPUs corresponding to the two or more matrix elements.

In response to there being two or more matrix elements that have decision values calculated by the matrix calculator as the greatest value, the virtual CPU selector may select a virtual CPU that has a priority that is higher from among the virtual CPUs corresponding to the two or more matrix elements.

In another aspect, there is provided a scheduling method for a multicore device including at least two cores, the scheduling method comprising detecting a virtual central processing unit (CPU) migration event with respect to a physical CPU of the multicore device, in response to a virtual CPU migration event with respect to the physical CPU being detected, calculating decision values for matrix elements of a decision matrix which correspond to virtual CPUs that are assigned to physical CPUs, selecting the virtual CPU corresponding to the matrix element that has the greatest decision value from among the calculated decision values, and changing a currently executed virtual CPU of the physical CPU in which the virtual CPU migration event has been detected, into the selected virtual CPU.

The calculating of the decision values may comprise calculating the decision values for the matrix elements of the decision matrix in consideration of a plurality of decision factors.

The decision factors may include weights corresponding to scheduling ratios of the physical CPUs.

The calculating of the decision values may comprise differentiating the weights based on differences between actual scheduling ratios and initial scheduling setting ratios of the physical CPUs.

The decision factors may include weights corresponding to workloads of the physical CPUs.

The calculating of the decision values may comprise differentiating the weights based on a number of virtual CPUs that have priorities that are higher than a predetermined priority from among the virtual CPUs assigned to the physical CPUs.

The calculating of the decision values may comprise differentiating the weights based on a total number of scheduling operations by virtual CPUs that have priorities that are higher than a predetermined priority from among the virtual CPUs assigned to the physical CPUs.

The decision factors may include a weight for a virtual CPU that has the highest scheduling priority from among the virtual CPUs.

In response to there being two or more matrix elements that have decision values calculated as the greatest value, the selecting may comprise selecting a virtual CPU that has a minimum number of scheduling operations from among the virtual CPUs corresponding to the two or more matrix elements.

In response to there being two or more matrix elements that have decision values calculated as the greatest value, the selecting may comprise selecting a virtual CPU that has a priority that is highest from among virtual CPUs corresponding to the two or more matrix elements.

In another aspect, there is provided a scheduling apparatus comprising an event detector configured to detect a virtual central processing unit (CPU) migration event with respect to a physical CPU of the multicore device, a matrix calculator configured to calculate decision values for matrix elements of a decision matrix which correspond to virtual CPUs that are assigned to physical CPUs, a CPU selector configured to select a virtual CPU corresponding to a matrix element that has a decision value from among the calculated decision values that has a value above a predetermined threshold, and a virtual CPU migration unit configured to change a currently executed virtual CPU of the physical CPU in which the virtual CPU migration has been detected, into the virtual CPU selected by the CPU selector.

Other features and aspects will be apparent from the following detailed description, the drawings, and the claims.

### BRIEF DESCRIPTION OF THE DRAWINGS

FIG. 1 is a diagram illustrating an example of scheduling for a multicore device.

FIG. 2 is a diagram illustrating an example of a scheduling apparatus for a multicore device.

FIG. 3 is a diagram illustrating an example of a decision matrix.

FIG. 4 is a diagram illustrating an example of decision values of the decision matrix shown in FIG. 3.

FIG. 5 is a flowchart illustrating an example of a scheduling method for a multicore device.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

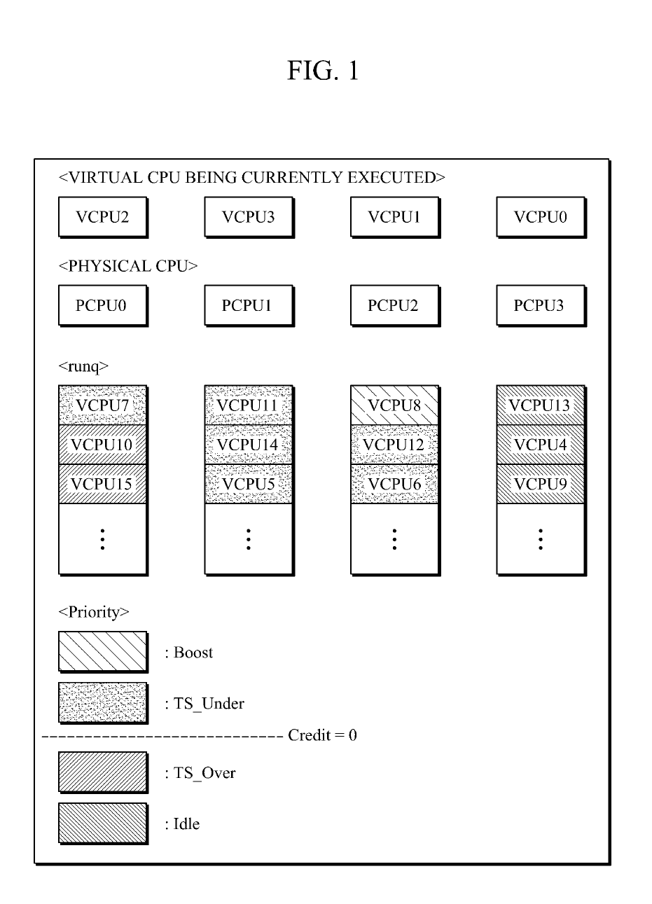

FIG. 1 illustrates an example of scheduling for a multicore device. For example, the multicore device may be a multicore processor.

Referring to FIG. 1, illustrated are physical CPUs PCPU0 through PCPU3, virtual CPUs VCPU0 through VCPU15, priority, and a priority list “runq”.

In this example, in the priority list “runq”, the virtual CPUs VCPU0 through VCPU15 are listed in the order of highest priority. Each virtual CPU has a priority from among the priorities “Boost”, “TS_Under”, “TS_Over”, and “Idle”.

For example, if a variable “credit” that is initially set to a positive integer and which decreases by 1 whenever a virtual CPU is once performed, is equal to or greater than 0, the priority of the corresponding virtual CPU may be set to “TS_Under”. As another example, if the variable “credit” is less than 0, the priority of the corresponding virtual CPU may be set to “TS_Over”.

When a domain such as a physical CPU is in an idle state, the priority of a virtual CPU assigned to the corresponding physical CPU may be set to “Idle”. As another example, when a virtual CPU is waiting for an event such as an I/O task or when a virtual CPU having a resource lock wakes up, the priority of the virtual CPU may be set to “Boost” which corresponds to the highest priority.

In this example, each physical CPU is occupied by the virtual CPUs listed in the corresponding priority list “runq”. In some examples, the virtual CPUs listed in the priority list “runq” of a different physical CPU may migrate to occupy a “runq” of another physical CPU. Because virtual CPUs may migrate, a policy for ensuring the fairness and load balance of the individual virtual CPUs is needed.

For example, an interrupt may occur to cause the migration of a virtual CPU from a “runq” of a physical CPU to a “runq” of another physical CPU. If an interrupt occurs to cause the migration of a virtual CPU that is currently being executed with respect to a specific physical CPU, the virtual CPU may move to the priority list “runq” of the corresponding physical CPU.

At this time, the virtual CPU may be inserted into the priority list “runq” of the physical CPU according to the priority of the virtual CPU. For example, if other virtual CPUs exist that have the same priority, the virtual CPU may be inserted and listed after the virtual CPUs having the same priority.

For example, a scheduler may search the priority list “runq” of the corresponding physical CPU to select a virtual CPU that has a priority that is higher than “TS_Under”. The scheduler may perform virtual CPU migration by changing a currently executed virtual CPU into the selected virtual CPU.

At this time, if a virtual CPU having a priority that is higher than “TS_Under” is not found in the priority list “runq” of the corresponding physical CPU, the scheduler may search for a virtual CPU that has a priority that is higher than “TS_Under” from the priority list “runq” of another physical CPU, and may select a virtual CPU that has a priority that is higher than “TS_Under”, and perform virtual CPU migration.

However, when the scheduler selects a virtual CPU from the priority list “runq” of another physical CPU for migration, the following examples may occur.

In a first example, a virtual CPU that has a priority that is higher than “TS_Under” exists in the priority list “runq” of another physical CPU. In this example, the migration of the virtual CPU may cause a situation in which the “runq” of the physical CPU has no more virtual CPUs that have a priority that is higher than “TS_Under” after virtual CPU migration occurs. At this time, when a virtual CPU of the physical CPU needs to migrate, it needs to search for a virtual CPU from the other physical CPU and migrate the virtual CPU, resulting in successive migrations of virtual CPUs. This can lead to a deterioration in processing speed.

In a second example, a virtual CPU that has a priority that is higher than “TS_Under” is searched and selected from the priority list “runq” of another physical CPU for migration of virtual CPUs, meanwhile, a workload of the physical CPU is never considered.

In other words, there is possibility that a virtual CPU listed in the priority list “runq” of a physical CPU having a higher workload migrates although migration of virtual CPUs listed in the priority list “runq” of a physical CPU having a lower workload has more excellent efficiency.

For example, a first physical CPU may have a greater workload and less efficient processing speed than a second physical CPU. Even though the second CPU has less workload, if the second physical CPU desires another virtual CPU, the migration of a virtual CPU listed in the priority list “runq” of the first physical CPU may occur and the virtual CPU listed in the priority list “runq” of the first physical CPU may migrate to the priority list “runq” of the second physical CPU.

In a third example, when a virtual CPU is selected and migrates from the priority list “runq” of another physical CPU, and a virtual CPU that has a priority that is “Boost” corresponding to the highest priority is first scheduled, but a virtual CPU that has a priority of “Boost” may never be considered because it is not checked whether there is a virtual CPU whose priority is “Boost”.

In a fourth example, when a virtual CPU is selected and migrates from the priority list “runq” of another physical CPU, initial scheduling setting ratios such as domain weights of physical CPUs may not be considered.

For example, assume that an initially set domain weight of two physical CPUs is 60:40. In this example, if an actual scheduling ratio of two physical CPUs currently scheduled is 55:45, a virtual CPU has to be selected from the priority list “runq” of the physical CPU whose scheduling ratio is 55 in order to adjust the scheduling ratio of 55:45 to the initially set domain weight of 60:40. However, such domain weights may never be considered.

To overcome these potential problems, described herein is a scheduling apparatus for a multicore device, which selects, upon migration of virtual CPUs in a multicore device, virtual CPUs in consideration of factors that affect scheduling in order to maintain the fairness and load balance of virtual CPUs in an optimal state.

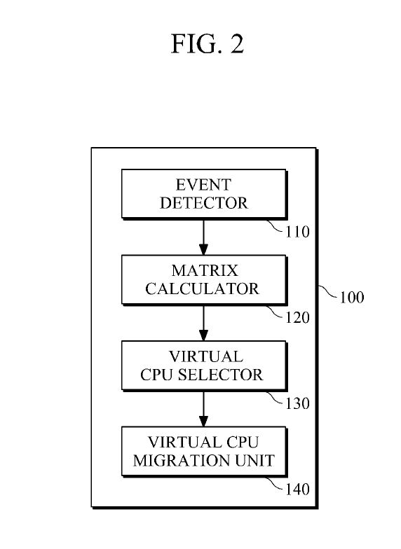

FIG. 2 is a diagram illustrating an example of a scheduling apparatus for a multicore device.

Referring to FIG. 2, scheduling apparatus 100 includes an event detector 110, a matrix calculator 120, a virtual CPU selector 130, and a virtual CPU migration unit 140.

The event detector 110 may detect a virtual CPU migration event with respect to a specific physical CPU of the multicore device that includes a plurality of cores. For example, the virtual CPU migration event with respect to the physical CPU may be an interrupt.

As an example, the event detector 110 may monitor whether an interrupt is generated in a virtual CPU that is currently being executed with respect to a specific physical CPU. When an interrupt is generated in the virtual CPU, the event detector 110 may determine that the virtual CPU is going to migrate.

When a virtual CPU migration event is detected with respect to the specific physical CPU, the matrix calculator 120 may calculate a decision value for each matrix element of a decision matrix composed of virtual CPUs assigned to the physical CPUs.

The matrix calculator 120 may calculate a decision value for each matrix element in consideration of a plurality of decision factors. An example of the decision factors may include weights corresponding to scheduling ratios of physical CPUs. For example, the matrix calculator 120 assign different weights based on the differences between actual scheduling ratios and initial scheduling setting ratios (that is, domain weights) of physical CPUs.

For example, the matrix calculator 120 may assign different weights in such a manner to assign a higher weight when a value obtained by subtracting an actual scheduling ratio of the physical CPU from its initial scheduling setting ratio is relatively great, and assign a lower weight when the obtained value is relatively small.

For example, the decision factors may include weights corresponding to workloads of physical CPUs. In this example, the matrix calculator 120 may assign different weights based on the number of virtual CPUs that have priorities that are higher than a predetermined priority from among the virtual CPUs assigned to the physical CPUs.

As another example, the matrix calculator 120 may assign different weights based on the total number of scheduling operations by virtual CPUs that have priorities that are higher than a predetermined priority from among the virtual CPUs assigned to the physical CPUs.

For example, a variable “credit” may be defined and may be initially set to a predetermined positive integer and may be reduced by 1 each time a virtual CPU is executed. The matrix calculator 120 may assign differentiated weights in such a manner to assign higher weights to the virtual CPUs of physical CPUs that have smaller sums of scheduling operations from among the virtual CPUs of the physical CPUs that have priorities that are higher than a predetermined priority, for example, to the virtual CPUs of the physical CPUs that have greater sums of variables “credit”. The matrix calculator 120 may assign lower weights to the virtual CPUs of the physical CPUs that have greater sums of scheduling operations from among the virtual CPUs of the physical CPUs that have priorities that are higher than the predetermined priority, for example, to the virtual CPUs of the physical CPUs that have smaller sums of variables “credit”.

For example, the decision factors may include weights for virtual CPUs that have priorities that are the highest. For example, the matrix calculator 120 may differentiate weights by assigning higher weights to virtual CPUs that have priorities that are set to “Boost” which corresponds to the highest priority.

When calculating decision values in consideration of a plurality of decision factors, the matrix calculator 120 may sum values of the plurality of decision factors to which differentiated weights are assigned to calculate the decision values. Meanwhile, the matrix calculator 120 may assign higher weights to more important decision factors.

For example, the matrix calculator 120 may calculate decision values by summing values of decision factors to which weights corresponding to scheduling ratios of physical CPUs are reflected, by summing values of decision factors to which weights corresponding to workloads of the physical CPUs are reflected, and/or by summing values of decision factors to which weights corresponding to virtual CPUs that have the highest priorities are reflected.

As another example, when the decision factor “highest priority” is set to an important decision factor according to device or system characteristics, the matrix calculator 120 may calculate decision values by summing values of decision factors to which weights corresponding to scheduling ratios of physical CPUs are reflected, by summing values of decision factors to which weights corresponding to workloads of the physical CPUs are reflected, and/or by summing values obtained by further assigning additional weights to values of decision factors to which weights corresponding to virtual CPUS that have the highest priorities are reflected.

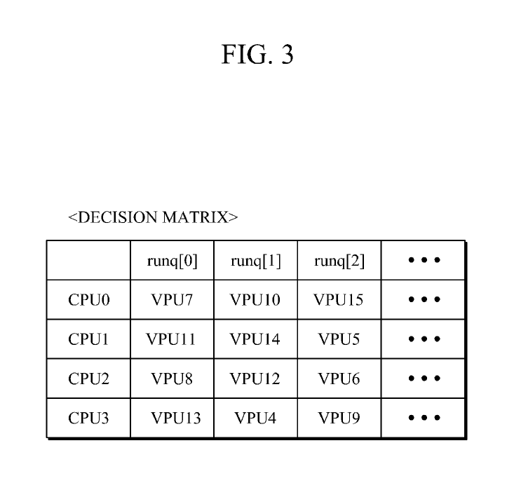

FIG. 3 illustrates an example of a decision matrix.

Referring to FIG. 3, virtual CPUs (VPU0 through VPU15) assigned to four physical CPUs (CPU0, CPU1, CPU2 and CPU3) are expressed as a decision matrix. In this example, the virtual CPUs (VPU0 through VPU15) are arranged in the order of higher priorities for each physical CPU.

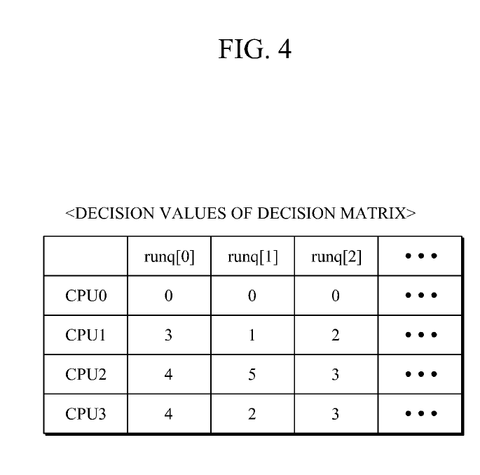

FIG. 4 illustrates an example of decision values of the decision matrix shown in FIG. 3.

Referring to FIGS. 1 and 4, decision values calculated in consideration of a plurality of decision factors by the matrix calculator 120 are matrix elements of the decision matrix.

For example, the virtual CPU selector 130 may select a virtual CPU corresponding to a matrix element that has the greatest value from among the decision values calculated by the matrix calculator 120. Referring to FIGS. 3 and 4, matrix element positioned in the third row, second column of the decision matrix (VPU12) has the greatest value. Accordingly, VPU12 corresponding to the matrix element that has the greatest value is selected as a virtual CPU that is to be migrated by the virtual CPU selector 130.

As another example, instead of selecting the virtual CPU that corresponds to a matrix element having the greatest value, the CPU selector 130 could select any virtual CPU that corresponds to a matrix element having a value that satisfies a threshold value. For example, a threshold value may be set to three, and the CPU selector could select any virtual CPU that corresponds to a matrix element having a value that is greater than a threshold value of three. In this example, the CPU selector could select VPU11, VPU8, VPU13, as well as VPU 12.

For example, the virtual CPU migration unit 140 may perform virtual CPU migration by changing a virtual CPU that is currently being executed with respect to a physical CPU in which a virtual CPU migration event has been generated, into the virtual CPU selected by the virtual CPU selector 130. For example, the virtual CPU migration unit 140 may insert a virtual CPU that is currently being executed with respect to a physical CPU in which a virtual CPU migration event has been generated into the decision matrix, and then may change a currently executed virtual CPU into the virtual CPU selected by the CPU selector 130.

In this example, the scheduling apparatus for the multicore device includes a plurality of cores. Upon migration of virtual CPUs, the scheduling apparatus may select virtual CPUs in consideration of a plurality of factors that affect scheduling performance, and the fairness and load balance of virtual CPUs may be maintained in an optimal state.

For example, when there are two or more matrix elements corresponding to two or more virtual CPUs that have the greatest decision values calculated by the matrix calculator 120, the virtual CPU selector 130 of the scheduling apparatus 100 (see FIG. 2) may select a virtual CPU from among the two or more virtual CPUs which has a minimum number or least amount of scheduling operations.

As another example, when there are two or more matrix elements corresponding to two or more virtual CPUs that have the greatest decision values calculated by the matrix calculator 120, the virtual CPU selector 130 may select a virtual CPU that has a priority that is higher from among the two or more virtual CPUs.

That is, when there are two or more matrix elements that have decision values calculated by the matrix calculator 120 that are the greatest value, the virtual CPU selector 130 may select one of the matrix elements to migrate.

As another example, when there are two or more matrix elements whose decision values are the greatest value, any one of the matrix elements may be arbitrarily selected for migration of a virtual CPU. In this example, there is possibility that a virtual CPU having low efficiency may be selected. Accordingly, by selecting a virtual CPU that has the smallest number of scheduling operations or a virtual CPU that has a priority that is higher from among the two or more virtual CPUs corresponding to matrix elements whose decision values are the greatest value, a virtual CPU having higher efficiency is selected.

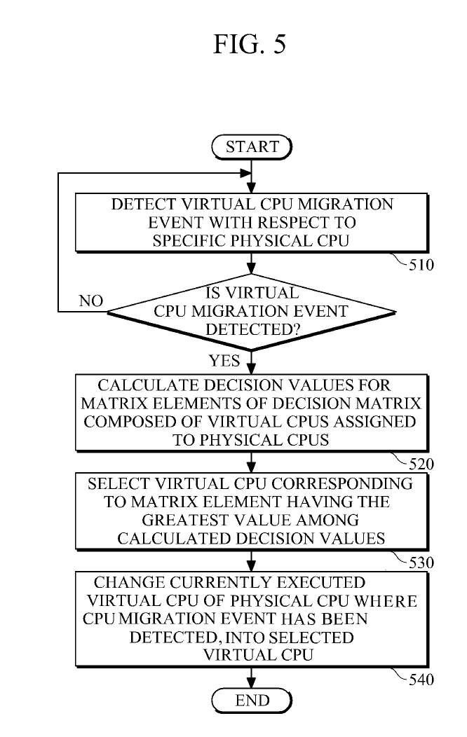

Hereinafter, a virtual CPU migration process which is performed by the scheduling apparatus 100 (see FIG. 2) for the multicore device is described with reference to FIG. 5.

FIG. 5 illustrates an example of a scheduling method for the multicore device.

In 510, the scheduling apparatus detects a virtual CPU migration event with respect to a specific physical CPU. For example, the virtual CPU migration event may be an interrupt.

For example, the scheduling apparatus may monitor whether an interrupt is generated in a virtual CPU that is currently being executed with respect to a specific physical CPU to determine that the virtual CPU has to migrate.

When a virtual CPU migration event with respect to the specific physical CPU is detected in 510, the scheduling apparatus calculates a decision value for each matrix element of a decision matrix composed of virtual CPUs assigned to the physical CPUs, in 520. For example, the scheduling apparatus may calculate a decision value for each matrix element in consideration of a plurality of decision factors.

For example, the decision factors may include weights corresponding to scheduling ratios of the physical CPUs. As an example, the scheduling apparatus may assign different weights based on the differences between the actual scheduling ratios and initial scheduling setting ratios (that is, domain weights) of the physical CPUs.

For example, the scheduling apparatus may assign differentiated weights in such a manner to assign a higher weight when a value obtained by subtracting an actual scheduling ratio of the physical CPU from its initial scheduling setting ratio is relatively great, and assign a lower weight when the obtained value is relatively smaller.

As another example, the decision factors may include weights corresponding to workloads of the physical CPUs. In this example, the scheduling apparatus may assign differentiated weights based on the number of virtual CPUs that have priorities that are higher than a predetermined priority from among the virtual CPUs assigned to the physical CPUs.

As another example, the scheduling apparatus may assign differentiated weights based on the total number of scheduling operations by virtual CPUs that have priorities that are higher than a predetermined priority from among the virtual CPUs assigned to the physical CPUs.

For example, a variable “credit” may be defined and may be initially set to a predetermined positive integer that has a value that is reduced by 1 each time the virtual CPU is executed. For example, the scheduling apparatus may assign differentiated weights in such a manner to assign higher weights to the virtual CPUs of physical CPUs that have smaller sums of scheduling operations from among the virtual CPUs of the physical CPUs that have priorities that are higher than a predetermined priority, that is, to the virtual CPUs of physical CPUs having greater sums of variables “credit”. As another example, the scheduling apparatus may assign lower weights to the virtual CPUs of physical CPUs that have greater sums of scheduling operations from among the virtual CPUs of physical CPUs that have priorities that are higher than the predetermined priority, that is, to the virtual CPUs of physical CPUs that have smaller sums of variables “credit”.

For example, the decision factors may include weights for virtual CPUs that have priorities that are the highest. That is, the scheduling apparatus may differentiate weights by assigning higher weights to virtual CPUs that have priorities that are set to “Boost” which corresponds to the highest priority.

When calculating decision values in consideration of a plurality of decision factors, the scheduling apparatus may sum values of the plurality of decision factors to which differentiated weights are assigned to calculate the decision values. Meanwhile, the scheduling apparatus may assign higher weights to more important decision factors.

For example, the scheduling apparatus 100 may calculate decision values by summing values of decision factors to which weights corresponding to scheduling ratios of physical CPUs are reflected, by summing values of decision factors to which weights corresponding to workloads of the physical CPUs are reflected, and/or by summing values of decision factors to which weights corresponding to virtual CPUS that have the highest priorities are reflected.

When the decision factor “highest priority” is set to an important decision factor according to device or system characteristics, the scheduling apparatus 100 may calculate decision values by summing values of decision factors to which weights corresponding to scheduling ratios of physical CPUs are reflected, by summing values of decision factors to which weights corresponding to workloads of the physical CPUs are reflected, and/or by summing values obtained by further assigning additional weights to values of decision factors to which weights corresponding to virtual CPUS that have the highest priorities are reflected.

After a decision value for each matrix element of the decision matrix is calculated in 520, the scheduling apparatus selects the virtual CPU corresponding to the matrix element having the greatest value from among the calculated decision values, in 530.

Thereafter, the scheduling apparatus inserts a virtual CPU that is currently being executed with respect to a physical CPU in which a virtual CPU migration event has been generated into the decision matrix, and then performs virtual CPU migration, by changing a virtual CPU that is currently being executed with respect to a physical CPU in which a virtual CPU migration event has been generated, into the selected virtual CPU, in 540.

Accordingly, upon migration of virtual CPUs, the scheduling apparatus may select virtual CPUs in consideration of a plurality of factors affecting scheduling performance, and the fairness and load balance of virtual CPUs may be maintained in an optimal state.

The examples described herein may be directed towards a scheduling apparatus for a multicore device. The apparatus may schedule various virtual CPUs to different “runqs” corresponding to different physical CPUs. The scheduler can schedule the virtual CPUs based on various factors that may take into consideration the amount of scheduling operations to be performed by a physical CPU, the number of remaining virtual CPUs in a “runq” of a physical CPU, and the like.

The processes, functions, methods, and/or software described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A scheduling apparatus for a multicore device including at least two cores, the scheduling apparatus comprising:
an event detector configured to detect a virtual central processing unit (CPU) migration event with respect to a physical CPU of the multicore device;
a matrix calculator configured to calculate decision values for matrix elements of a decision matrix which correspond to virtual CPUs that are assigned to physical CPUs, in response to a virtual CPU migration event with respect to the physical CPU being detected by the event detector;
a CPU selector configured to select a virtual CPU corresponding to a matrix element that has the greatest decision value from among the calculated decision values; and
a virtual CPU migration unit configured to change a currently executed virtual CPU of the physical CPU in which the virtual CPU migration has been detected, into the virtual CPU selected by the CPU selector.

2. The scheduling apparatus of claim 1, wherein the matrix calculator calculates the decision values for the matrix elements of the decision matrix in consideration of a plurality of decision factors.

3. The scheduling apparatus of claim 2, wherein the decision factors include weights corresponding to scheduling ratios of the physical CPUs.

4. The scheduling apparatus of claim 3, wherein the matrix calculator differentiates the weights based on differences between actual scheduling ratios and initial scheduling setting ratios of the physical CPUs.

5. The scheduling apparatus of claim 2, wherein the decision factors include weights corresponding to workloads of the physical CPUs.

6. The scheduling apparatus of claim 5, wherein the matrix calculator differentiates the weights based on a number of virtual CPUs that have priorities that are higher than a predetermined priority from among the virtual CPUs assigned to the physical CPUs.

7. The scheduling apparatus of claim 5, wherein the matrix calculator differentiates the weights based on a total number of scheduling operations by virtual CPUs that have priorities that are higher than a predetermined priority from among the virtual CPUs assigned to the physical CPUs.

8. The scheduling apparatus of claim 2, wherein the decision factors include a weight for a virtual CPU that has the highest scheduling priority from among the virtual CPUs.

9. The scheduling apparatus of claim 2, wherein, in response to there being two or more matrix elements that have decision values calculated by the matrix calculator as the greatest value, the virtual CPU selector selects a virtual CPU that has a minimum number of scheduling operations from among the virtual CPUs corresponding to the two or more matrix elements.

10. The scheduling apparatus of claim 2, wherein, in response to there being two or more matrix elements that have decision values calculated by the matrix calculator as the greatest value, the virtual CPU selector selects a virtual CPU that has a priority that is higher from among the virtual CPUs corresponding to the two or more matrix elements.

11. A scheduling method for a multicore device including at least two cores, the scheduling method comprising:
detecting a virtual central processing unit (CPU) migration event with respect to a physical CPU of the multicore device;
in response to a virtual CPU migration event with respect to the physical CPU being detected, calculating decision values for matrix elements of a decision matrix which correspond to virtual CPUs that are assigned to physical CPUs;
selecting the virtual CPU corresponding to the matrix element that has the greatest decision value from among the calculated decision values; and
changing a currently executed virtual CPU of the physical CPU in which the virtual CPU migration event has been detected, into the selected virtual CPU.

12. The scheduling method of claim 11, wherein the calculating of the decision values comprises calculating the decision values for the matrix elements of the decision matrix in consideration of a plurality of decision factors.

13. The scheduling method of claim 12, wherein the decision factors include weights corresponding to scheduling ratios of the physical CPUs.

14. The scheduling method of claim 13, wherein the calculating of the decision values comprises differentiating the weights based on differences between actual scheduling ratios and initial scheduling setting ratios of the physical CPUs.

15. The scheduling method of claim 12, wherein the decision factors include weights corresponding to workloads of the physical CPUs.

16. The scheduling method of claim 15, wherein the calculating of the decision values comprises differentiating the weights based on a number of virtual CPUs that have priorities that are higher than a predetermined priority from among the virtual CPUs assigned to the physical CPUs.

17. The scheduling method of claim 15, wherein the calculating of the decision values comprises differentiating the weights based on a total number of scheduling operations by virtual CPUs that have priorities that are higher than a predetermined priority from among the virtual CPUs assigned to the physical CPUs.

18. The scheduling method of claim 12, wherein the decision factors include a weight for a virtual CPU that has the highest scheduling priority from among the virtual CPUs.

19. The scheduling method of claim 12, wherein, in response to there being two or more matrix elements that have decision values calculated as the greatest value, the selecting comprises selecting a virtual CPU that has a minimum number of scheduling operations from among the virtual CPUs corresponding to the two or more matrix elements.

20. The scheduling method of claim 12, wherein, in response to there being two or more matrix elements that have decision values calculated as the greatest value, the selecting comprises selecting a virtual CPU that has a priority that is highest from among virtual CPUs corresponding to the two or more matrix elements.

21. A scheduling apparatus comprising:
an event detector configured to detect a virtual central processing unit (CPU) migration event with respect to a physical CPU of the multicore device;
a matrix calculator configured to calculate decision values for matrix elements of a decision matrix which correspond to virtual CPUs that are assigned to physical CPUs;
a CPU selector configured to select a virtual CPU corresponding to a matrix element that has a decision value from among the calculated decision values that has a value above a predetermined threshold; and
a virtual CPU migration unit configured to change a currently executed virtual CPU of the physical CPU in which the virtual CPU migration has been detected, into the virtual CPU selected by the CPU selector.
